(19) United States
(12) Patent Application Publication
(10) Pub. No.: US 2003/0037253 A1
(43) Pub. Date: Feb. 20, 2003

(54) Digital rights management system

(76) Inventors: Arthur Blank, Encinitas, CA (US); Len Schiedel, Encinitas, CA (US)

Correspondence Address: ROYAL W. CRAIG, A PROFESSIONAL CORPORATION, SUITE 153, 10 NORTH CALVERT STREET, BALTIMORE, MD, 21202, US

(21) Appl. No.: 10/135,188

(22) Filed: Apr. 29, 2002

Related U.S. Application Data
(60) Provisional application No. 60/287,167, filed on Apr. 27, 2001.

(51) Int. Cl. H04L 9/00

(52) U.S. Cl. 713/200

(57) ABSTRACT

An improved software application for digital rights management, providing the means to control the interaction between a client's computer/monitor and a remote server on which the present invention and the creative work of an author/inventor reside, is herein disclosed. A key aspect of the present invention is the series of applets that selectively disable certain functions (e.g. “Save File”, “Print File”, “Download File”, “Print Screen”, copy/save to “Clipboard”) contained in most existing browsers. Any attempt to use one of these functions results in, at least, the disabling of the feature and/or the display of an error message. Other features include certain e-commerce functions and encryption of data passed between the remote server and the client machine. In this manner, the information (i.e. text and images) resident on the client's browser running the software application according to the present invention is thereby protected from misuse/misappropriation. While the primary purpose underlying the present invention is the protection of creative works of authorship/inventorship, the software application also contains features that provide the client with some degree of control over the manner in which the information is displayed on his/her monitor.

### CROSS-REFERENCE TO RELATED APPLICATIONS

The present application derives priority from U.S. provisional application No.60/287,167 for “DIGITAL RIGHTS MANAGEMENT SYSTEM”; filed Apr. 27, 2001.

### BACKGROUND OF THE INVENTION

1. Field of the Invention

The present invention relates to computer software for controlling access to digital content and, more particularly, to a system for providing managerial control over access rights to digital information available via the Internet in order to protect the intellectual property rights inherent therein.

2. Description of the Background

The protection of the intellectual property rights, primarily copyrights, inherent in the digital information available on the Internet has been problematic since its inception. Policing activities such as file copying/downloading that occur within private homes with Internet access is virtually impossible (i.e. without the implementation of the all-seeing, all-knowing “Big Brother” technology described in George Orwell's novel entitled “1984”). To allow this infringement to continue unchecked and unabated would, in time, prove to be a disincentive to authors and inventors. Without the means to benefit (i.e. profit) from their efforts, one of the motivating factors for creating new forms of entertainment (e.g. books), technology, etc. would be eliminated. In time, the resulting reduction in the volume of new “creativity” would have serious, detrimental consequences for the quality of life enjoyed by the general public.

The issues outlined above are obvious to one with ordinary skill in the art, and a means to address them is not known to exist. It would, therefore, be advantageous to provide software for use with the Internet that allows an author or inventor to control the degree of access that the public has to his/her creative work. Software possessing this capability would serve to balance the interests of the author/inventor in realizing gain from their efforts while providing a sufficient degree of access for the public (i.e. a degree of access comparable in many ways to that of the pre-Internet era, yet with the enhanced retrievability provided by the Internet).

### SUMMARY OF THE INVENTION

It is, therefore, the primary objective of the present invention to provide an improved software application that allows an author or inventor to control the degree of access that the public has to his/her creative work.

It is another objective of the present invention to provide an improved software application that allows an author or inventor to control the degree of access to his/her creative work via Internet-based computer systems (i.e. digital rights management).

It is still another objective of the present invention to provide an improved software application that transmits information in an encrypted format to prevent any inappropriate use of intercepted data.

It is yet another objective of the present invention to provide an improved software application that allows the client to manipulate the information being viewed on his/her monitor.

In accordance with the above objects, one embodiment of an improved software application for digital rights management provides the means to control the interaction between a client's computer/monitor and a remote server on which the present invention and the creative work of an author/inventor reside. A key aspect of the present invention is the ability to disable certain functions (e.g. “Save File”, “Print File”, “Download File”, “Print Screen”, copy/save to “Clipboard”) contained in most existing browsers. Any attempt to use one of these functions results in either the function being disabled or not working, the display of a warning message on the client's monitor, or the termination of the client's trial/free access or subscription rights. Another information protection feature of the present invention involves the encryption of all data being passed between the server and the client's computer/monitor. The encrypted data format prevents any inappropriate use of data intercepted by parties other than the client. The information (i.e. text and images) resident on the client's browser running the software application according to the present invention is thereby protected from misuse/misappropriation.

While the primary purpose underlying the present invention is the protection of creative works of authorship/inventorship, the software application also contains features that provide the client with a significant degree of control over the manner in which the information is displayed on his/her monitor. The present invention provides the data in a rich text format that allows the client to, for example, modify the font's type, size, and/or color, or download a document with or without the included images.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a print of a webpage utilizing elements of a first embodiment of the present invention.

FIG. 2 is a print of a second webpage utilizing elements of a first embodiment of the present invention.

FIG. 3 is a print of a web page containing the scrollable text box which can be accessed via a link on the webpage of FIG. 2.

FIG. 4 is a print of a webpage accessed via a link on the webpage of FIG. 2.

FIG. 5 is a print of another webpage accessed via a link on the webpage of FIG. 2.

FIG. 6 is a print of yet another webpage accessed via a link on the webpage of FIG. 2.

FIG. 7 is a print of still another webpage accessed via a link on the webpage of FIG. 2.

FIG. 8 is a print of another webpage accessed via a link on the webpage of FIG. 2.

Appendices 1-3 (with subparts) are source code listings for the respective ReaderApp applet, SecureImage applet, and ImageEditor applet.

### DETAILED DESCRIPTION OF THE PREFERRED EMBODIMENTS

The present invention is a system for providing managerial control over access rights to digital information available via the Internet in order to protect the intellectual property rights inherent therein. The system provides the means to control the interaction between a client's computer/monitor and a remote server on which the present invention and the creative work of an author/inventor reside. The system is reduced to practice in the form of a series of Java® applets that execute on the client's browser when the remote server is accessed by the client. In contrast to other prior art content management software, the present system confers a great advantage inasmuch as it does not compel loading/downloading of any software (such as “plug-ins” or “executables”) onto the client's computer. Everything takes place within the applets in the client's browser with the client's computer/monitor serving only as a means to view the information content. The present system incorporates an array of features/functions that place author/inventor-defined limitations on the actions of the client.

One key aspect of the present invention is the ability to disable certain standard computer functions (e.g. “Save File”, “Print File”, “Download File”, “Print Screen”, copy/save to “Clipboard”) contained in most conventional software applications. These functions, or variations thereof, are normally intended to provide the client with the means for file/information management (i.e. the ability to save, print, and/or cut/paste information generated by the client). Unfortunately, in the context of an Internet browser such as Microsoft Explorer® or Netscape Navigator®, these same functions are often used to save, print, and/or cut/paste Internet-based content, actions that may infringe the copyrights inherent in that information (i.e. use of the information without the approval of, or payment of a royalty to, the copyright holder). The Java® applets according to the present invention run on the client's browser and recognize when the client is attempting to access one of these functions while viewing/reviewing the creative work. Any recognized attempt to access any one of these functions initiates a two-step client/software application response. First, an error message (e.g. “Use of the Print-Screen command is not allowed”) is transmitted and displayed on the client's screen. Second, the Java® applets send an alert message to the web server to notify the system administrator of the client's actions so that any required remedial measures can be pursued (e.g. cancellation of client account/subscription, termination of connection to website).

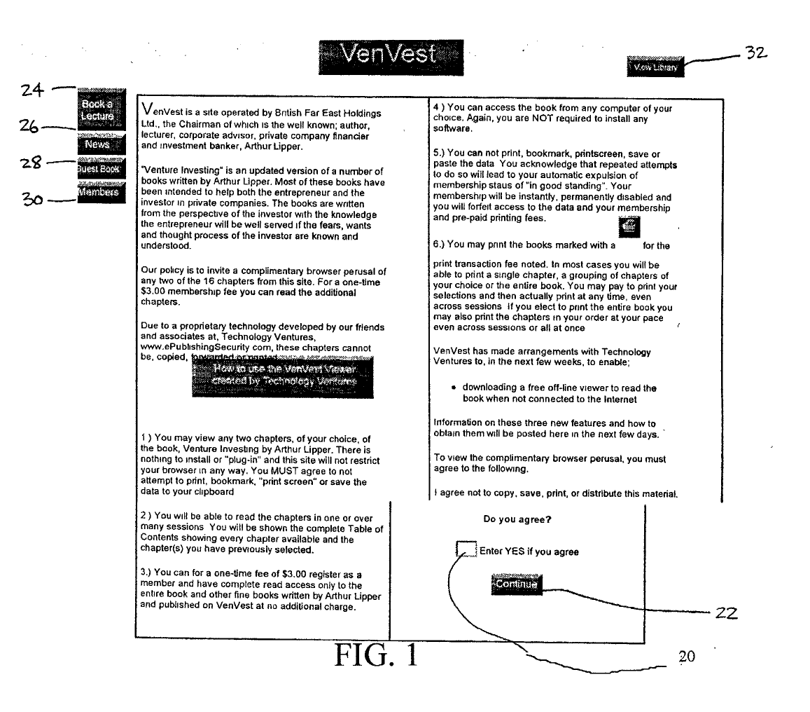

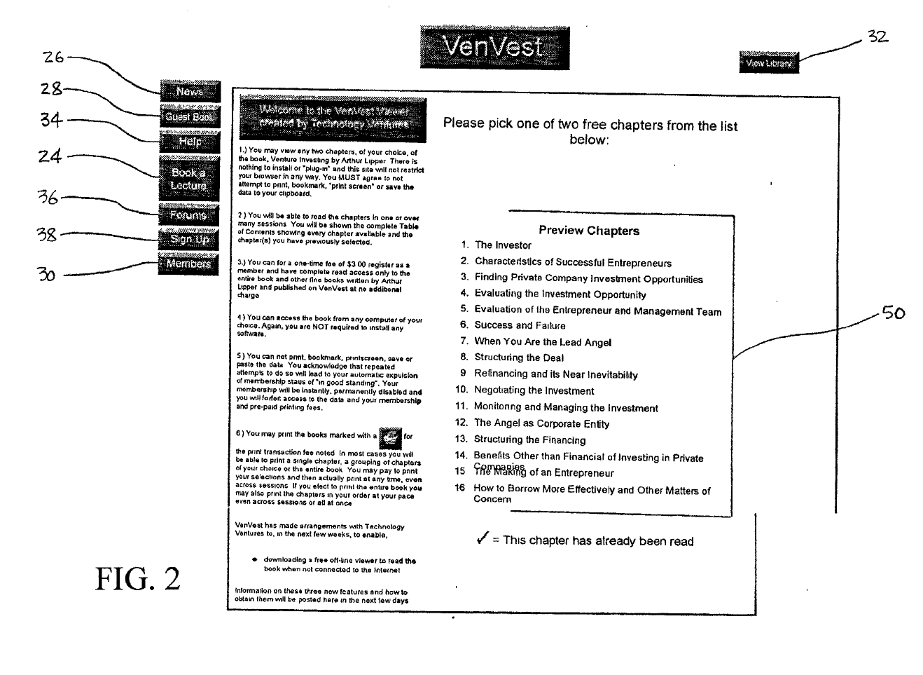

Another key aspect of the present invention is the web-content author's/inventor's ability to enable certain e-commerce functions. These functions include “Single Print”, “Multiple Print”, “Print Some or All”, “Free Try/Buy”, “Timed Subscription”, “Pay Per View”, “Single or Multiple Save”, “Selective Protections” (e.g. a low resolution image is not protected due to its limited usefulness/appeal, but a high resolution image is protected), “Charge for Timed View”, “Charge to Print”, “Expire Over Time”, and many others (see discussion of FIGS. 1 and 2 below). This provides an author/inventor with tremendous flexibility as to how and to what extent their creative work is made accessible to the public.

The present system also allows an author/inventor to provide the public with free, limited or one-time-use access to their creative work via the use of Internet “cookies.” If a client possesses knowledge of methods (i.e. computer hacking) to modify or delete “cookie” data, that individual could attempt to access the protected information an unauthorized number of times. The present invention counteracts this activity by retaining certain data used to recognize the deletion, or attempted deletion, of “cookies” by those that seek to obtain multiple-use access to areas/functions with limited, or one-time-use, access.

Another feature of the present system involves the encryption of all information being passed between the remote server and the client's computer/monitor. Information being passed between any two points on the Internet is subject to interception by those (i.e. computer hackers) with the requisite access and skills. The encrypted data format prevents any inappropriate use of information intercepted by parties other than the client.

Yet another data protection feature of the present invention prevents an individual from utilizing a third party program (i.e. one that is running concurrently on the client's computer) to “grab”elements of the author's/inventor's information appearing on the client's monitor. This feature involves the concept of keyboard “focus.” When the keyboard focus is set to the protected information, its text and/or images are visible on the client's monitor. However, if the client changes the keyboard focus to a concurrent program (e.g. to actuate a function key in an attempt to grab elements of the protected data for inappropriate use), the applet screen, now no longer the active one, immediately goes blank or displays alternative text (e.g. an error message as discussed above).

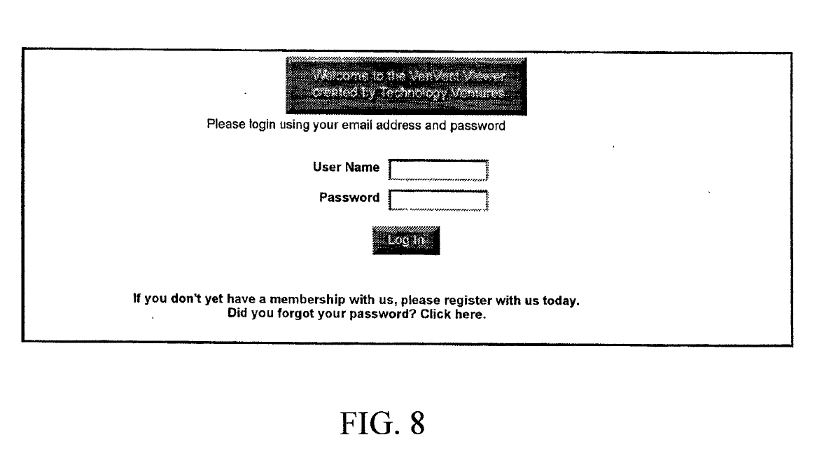

Another relatively common function found in many existing software programs is the ability to “bookmark” a page. The present invention includes a bookmarking function that allows a client to return to the point where he/she left off in a partially-read document. Control over the bookmarking function is thus available because it is only enabled after the client logs-in to his/her account. (See FIG. 8 for an example of a member log-in screen.)

While the primary purpose underlying the present invention is the protection of creative works of authorship/inventorship, the software application also contains features that provide the client with a significant degree of control over the manner in which the information is displayed on his/her monitor. The present invention provides content in HTML format. HTML formatting provides the client with the ability to (1) manipulate the font's type, size, and/or color, (2) to display images within the text of a document, and/or (3) download or display a document with or without the included images. This formatting functionality, as well as the bookmarking functionality, are critical to the utility of the present invention to the client when one realizes that extended and/or multiple periods of usage may be required, for example, to complete the reading of a lengthy novel.

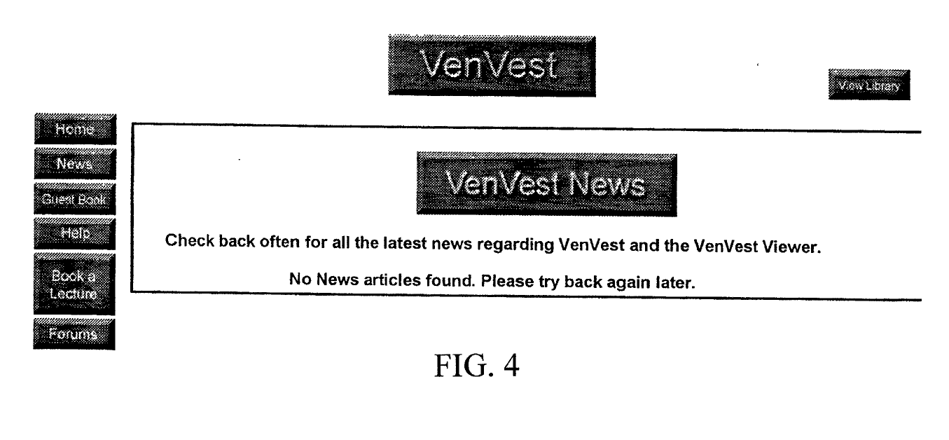

The exemplary use of the present invention is illustrated collectively in FIGS. 1-8. FIGS. 1-3 are prints of webpages utilizing elements of the present system. FIGS. 4-8 are prints of webpages accessed via links on the webpage of FIG. 2.

FIG. 1 shows the home webpage for www.venvest.com. The illustrated website serves to provide access to an exemplary non-fiction work by Arthur Lipper, III entitled “Venture Investing.” FIG. 2 shows the webpage that is accessed by a two-step process of (with reference to FIG. 1) entering “YES” in the box 20 and clicking on the “Continue” button 22. Note that the user is required to “agree not to copy, save, print, or distribute this material” before moving from the webpage of FIG. 1 to that of FIG. 2. In addition to much of the textual information and function buttons 24, 26, 28, 30, 32 of FIG. 1, FIG. 2 also includes text 50 and function buttons 34,36, 38.

If the client wishes to preview any of the chapters shown at right he clicks on that chapter. This initiates one of the Java applets of the present invention which runs on the client's computer within the client's browser window and takes control over the displaying of content provided by the server. This Java ReaderApp applet displays the content to the client via a scrollable text box.

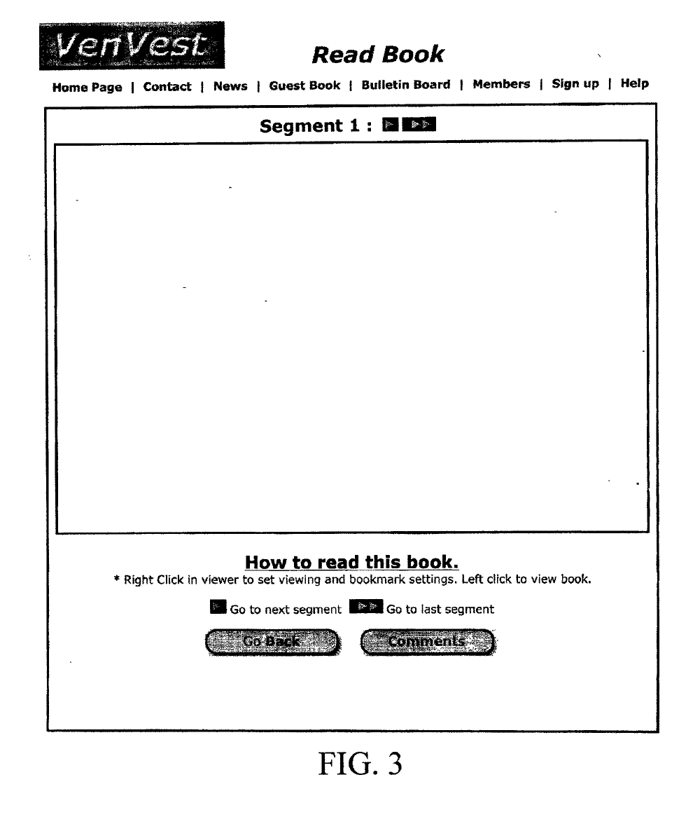

FIG. 3 is a print of a web page containing the scrollable text box for displaying content text provided by the server. The entire package of text passed between the remote server and the client's computer/monitor is encrypted for security. Presently, the encryption is accomplished using a simple and conventional text cypher such as, for example, CryptoTool. However, this can readily be replaced with SSL or any freely usable encryption algorithm. The encrypted data format prevents any inappropriate use of information intercepted by parties other than the client.

The package of text is encrypted from HTML format for easy delivery directly to the client's browser. With the HTML specification, documents created under different operating systems and with different software applications can be transferred between those operating systems and applications. The HTML format attributes include:

Font name

Font size

Character color

Bold

Italic

Underline

Strikethrough

Bulleted lists

The foregoing HTML formatting provides the client with the ability to manipulate the above-described characteristics including font type, size, and/or color. In addition, it is possible to display images within the text of a document, and/or download or display a document with or without included images. This functionality is critical to the utility of the present invention to the client when one realizes that extended periods of usage may be required, for example, to complete the reading of a lengthy novel.

The line-by-line scrolling display of HTML format data is an important facet of the present invention. Conventional “reader” systems tend to use proprietary formats such as Adobe® but this places restrictions on the client's ability to manipulate the document. HTML is not proprietary, but it can be a problem inasmuch as the end appearance of an HTML document depends largely on the client's particular monitor size and resolution. What looks like a perfect HTML document to the server may lose a significant portion of its formatting on the client end, thereby looking and printing poorly. The combined reader applets of the present invention gives the client line-by-line control of the HTML document. Specifically, the ReaderApp applet (Appendix 1) displays HTML but allows control over the meaning of the font and attribute tags (e.g., scale the point size or substitute different fonts). Thus, the client can scale the point sizes and override the font faces. The SecureImage applet allows the client to override the display/loading of images, and the ImageEditor applet selectively controls the editing of images. If a client pays for a premium access level, the client is free to cut text and paste directly, or save and open files using their own word processor.

Inasmuch as the reader applets run in real time on the client computer, they can control the client's environment as long as the browser is the active window. This is taken advantage of in managing the distribution of digital content. Certain standard computer functions are disabled as determined in accordance with the client's clearance level. For example, for a visiting client the “Save File”, “Print File”, “Download File”, “Print Screen”, copy/save to “Clipboard” of Microsoft Explorer® or Netscape Navigator® are all disabled. Specifically, this is accomplished by the executable code of the applet which actively monitors the client's browser (Microsoft Explorer® or Netscape Navigator® ) and recognizes when the client is attempting to access one of the protected functions. Of course, the applets themselves have no inherent copy/paste function, and the data is not in the browser's HTML control page. Instead, the applets use keyboard focus (described above) to notice when the Print-Screen key has been depressed. On seeing that the Print-Screen key has been clicked while keyboard focus existed (and the reader/applet would therefore be displaying content), the applets refuse to print. Instead, the applet just displays a gray rectangle or replaces whatever graphic may have been placed on the clipboard by putting in warning text. Any recognized attempt to access any one of the above-described functions initiates a two-step server/software application response. First, an error message (e.g. “Use of the Print File command is not allowed”) is transmitted and displayed on the client's screen. Second, the reader applets (Appendix 1) send an alert message to the web server to notify the system administrator of the client's actions so that any required remedial measures can be pursued (e.g. cancellation of client account/subscription, termination of connection to website). The same reader applets in a like manner control the client's printing ability including “Single Print”, “Multiple Print”, “Print Some or All”, “Free Try/Buy”, “Timed Subscription”, “Pay Per View”, “Single or Multiple Save”, “Selective Protections”, “Charge for Timed View”, “Charge to Print”, “Expire Over Time”, and many others. This provides the copyright holder with tremendous flexibility as to how and to what extent their creative work is made accessible to the public.

In addition to providing digital content management within the client's browser, the present reader applets also include code to prevent the use of third party programs (i.e. one that is running concurrently on the client's computer) to “grab” elements of the copyrighted content appearing on the client's monitor. For example, there is a well-known third party program that will save or print an exact copy of the contents of the client's screen. To activate it, the client normally clicks on a dedicated icon which activates the third party program. This ability is prevented by code which maintains keyboard “focus.” The present applets do not enforce keyboard focus, they merely use it to disable the display of content. In other words, the applets know when it has keyboard focus, it knows when it loses keyboard focus, and it is cognizant of when it regains keyboard focus (and refreshes content displayed on the screen). Thus, when the client changes the keyboard's focus to a concurrent third party program (e.g. to actuate a function key in an attempt to grab elements of the protected data for inappropriate use), the protected information's screen, now no longer the active one, immediately goes blank or displays an error message.

As described above, the present system also incorporates code to prevent modification or deletion of “cookie” data. At each visited site the applets record information on the client computer as a cookie, the cookie indicating what documents have been viewed for free. In addition, the present system relies on a dual-cookie system to prevent the deletion, or attempted deletion, of “cookies” by those that seek to obtain multiple-use access to areas/functions with limited, or one-time-use, access. To facilitate the use of the “Backup” cookie, the reader applets use a two step method to write the cookies. Thus, when entering a site, the reader applets examine the cookie. If the cookie is empty, the applets redirect the client temporarily and unnoticeably to another backup site to view its copy of the document. The second site has a different, unrelated domain name, and a page on that site saves the cookie to the browser using its domain name. Then the active reader applet is redirected automatically back to the original site, which then writes its copy of the cookie using its domain name. Thus the user would have to recognize that the cookie file for the second, innocuous named site, would need to be deleted, too.

The applets according to the present embodiment of the invention are encoded as three separate executable Java source code applets, inclusive of the following: 1) a “ReaderApp” applet (reader applet for text documents); 2) a “SecureImage” applet (viewer of graphic images); and 3) “ImageEditor” applet (for editing images). Each of the separate ReaderApp applet, SecureImage applet, and ImageEditor applet are further expressed in executable source code records arranged as follows, and the source code itself is appended hereto as shown below in Appendices (with subparts):

| 1. | ReaderApp applet (viewer for text documents) | | Appendix 1 |
|---|---|---|---|
| | A. | letter.java | Appendix 1.A |
| | B. | line.java | Appendix 1.B |
| | C. | MyPopupMenu.java | Appendix 1.C |
| | D. | ReaderAboutBox.java | Appendix 1.D |
| | E. | ReaderApp.java | Appendix 1.E |
| | G. | ReaderView.java | Appendix 1.F |
| 2. | SecureImage applet (viewer of graphic images) | | Appendix 2 |
| | A. | SecureViewerApp.java | Appendix 2.A |
| | B. | ViewerFrame.java | Appendix 2.B |
| | C. | ReaderUtil.java | Appendix 2.C |
| | D. | BookInfo.java | Appendix 2.D |
| 3. | ImageEditor applet (editting images) | | Appendix 3 |
| | A. | ImageEditor.java | Appendix 3.A |
| | B. | ImageEditorCanvas.java | Appendix 3.B |
| | C. | ImageLayer.java | Appendix 3.C |

The user-functionality of the applet approach to content management is enhanced by a series of additional web pages that the user may access as desired. These web pages are shown in FIGS. 4-8, all of which are prints of webpages accessed via links on the webpage of FIG. 2.

FIG. 4 is a webpage from the www.venvest.com website that is accessed by clicking on the “News” function button 26 of the webpage shown in FIG. 2. It is a webpage dedicated to the publishing of the latest information concerning VenVest.com.

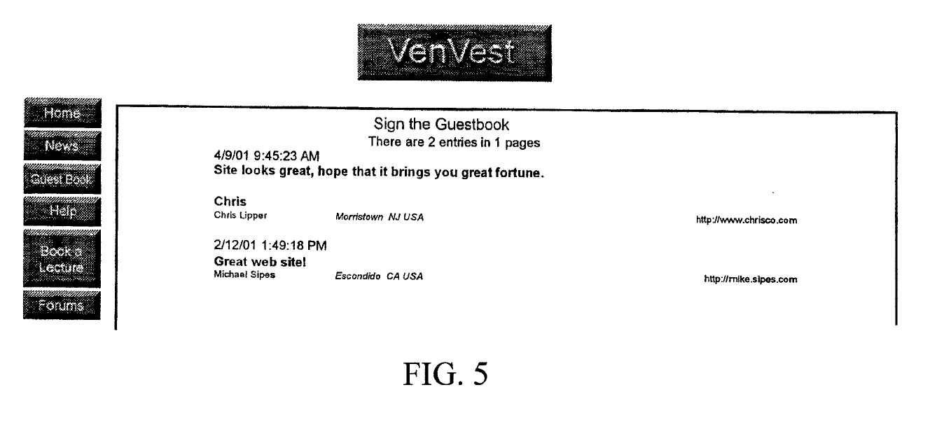

FIG. 5 is a webpage from the www.venvest.com website that is accessed by clicking on the “Guest Book” function button 28 of the webpage shown in FIG. 2. It is a webpage that offers visitors an opportunity to review comments that others have e-mailed to the VenVest.com website.

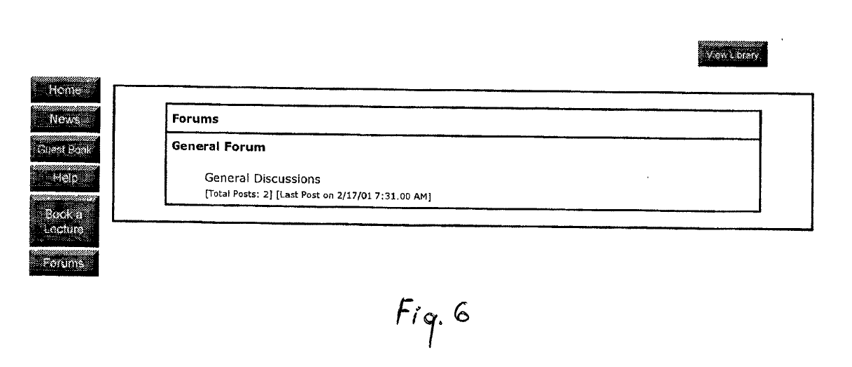

FIG. 6 is a webpage from the www.venvest.com website that is accessed by clicking on the “Forums” function button 36 of the webpage shown in FIG. 2. It is a webpage dedicated to providing members of the VenVest.com community with the means to conduct ongoing dialogues with other members on a variety of topics.

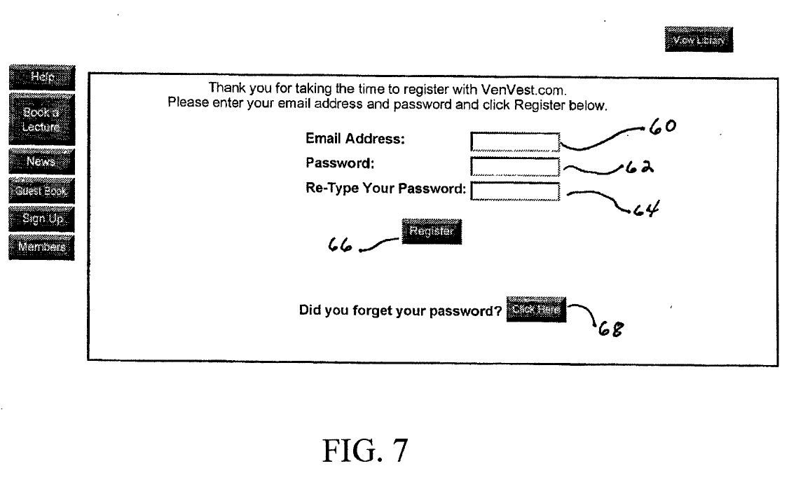

FIG. 7 is a webpage from the www.venvest.com website that is accessed by clicking on the “Sign Up” function button 38 of the webpage shown in FIG. 2. It is a webpage that allows a visitor to become a member of VenVest.com by entering an e-mail address in box 60, entering a password in boxes 62 and 64, and clicking on the “Register” button 66. If a registrant has forgotten the password that he/she established, clicking on the “Click Here” button 68 leads that individual through a process that assists in reacquiring one's password before providing access to the members-only areas of the website.

FIG. 8 is a webpage from the www.venvest.com website that is accessed by clicking on the “Members” function button 30 of the webpage shown in FIG. 2. It is a webpage that allows a VenVest.com member to acquire/reacquire access to the Viewer utilized to read the entire contents of any of the website's publications.

The help information webpage (not shown in the Figures) accessed by clicking on the “Help” button 34 of FIG. 2, contains primarily a restatement of the information in the paragraphs numbered 1 through 6 in either FIG. 1 or FIG. 2. Clicking on the “Book a Lecture” button 24 of FIG. 2 opens a new e-mail message screen (not shown in the Figures) with the e-mail address of the site contact (e.g., author) already entered on the “TO:” line. The library webpage (not shown in the Figures) accessed by clicking on the “View Library” button 32 of FIG. 2, provides access to the publications (e.g. the aforementioned non-fiction work by Arthur Lipper, III entitled “Venture Investing”) available to the public via the Venvest.com website.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A system for providing managerial control over access rights to digital information, comprising a reader applet that is executable when a client attempts to view selected remote content in a browser window, the applet controlling the client's ability to use certain standard computer functions from among the group including “Save File”, “Print File”, “Download File”, “Print Screen”, “Copy/save to Clipboard”.

2. The system for providing managerial control over access rights to digital information according to claim 1, wherein said reader applet recognizes when the client is attempting to access one of said functions while viewing/reviewing the remote content and transmits/displays an error message on the client's screen, and also sends an alert message to the remote web server to notify the system administrator of the client's actions.

3. The system for providing managerial control over access rights to digital information according to claim 1, wherein said reader applet provides limited or one-time-use access to selected remote content by writing a cookie to the client's computer to record each viewing of remote content, and said reader applet recognizes the deletion and attempted deletion of cookies by any user that seeks to obtain multiple-use access to said remote content.

4. The system for providing managerial control over access rights to digital information according to claim 1, wherein all remote content transmitted to the reader applet on the client's computer is encrypted by the remote server and decrypted by the reader applet for display on the client's computer/monitor.

5. The system for providing managerial control over access rights to digital information according to claim 1, wherein said reader applet maintains keyboard focus to prevent a client from utilizing third party programs to save or print protected content.

6. The system for providing managerial control over access rights to digital information according to claim 1, wherein said reader applet includes a bookmarking function that allows a client to return to the point where he/she left off in a partially-read document.

7. A system for providing managerial control over access rights to digital information, comprising:
a text reader applet, which is executable when a client attempts to view a remote text document in a browser window, for controlling the client's ability to use standard computer functions among the group comprising “Save File”, “Print File”, “Download File”, “Print Screen”, “Copy/save to Clipboard”;
an image reader applet, which is executable when a client attempts to view a remote image in a browser window, for controlling the client's ability to use standard computer functions among the group comprising “Save File”, “Print File”, “Download File”, “Print Screen”, “Copy/save to Clipboard”;
an image editor applet, which is executable when a client attempts to edit a remote image in a browser window, for controlling the client's ability to edit said image.
